(19) United States
(12) Patent Application Publication
(10) Pub. No.: US 2006/0112689 A1
(43) Pub. Date: Jun. 1, 2006

(54) Divided housing turbocharger with a variable nozzle area

(76) Inventors: Patrick W. Savage JR., Chillicothe, IL (US); Christopher R. Gehrke, Chillicothe, IL (US); James H. Mutti JR., East Peoria, IL (US); David M. Costura, Peoria, IL (US); Joshua D. Keyes, East Peoria, IL (US); Steven J. Funke, Mapelton, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/998,739

(22) Filed: Nov. 30, 2004

(51) Int. Cl. F02D 23/00; F02B 33/44

(52) U.S. Cl. 60/602; 60/605.1

(57) ABSTRACT

A turbocharger for a power system is provided. The turbocharger has a turbine and a housing enclosing the turbine. The housing has a first annular passageway and a second annular passageway. Both of the first and second annular passageways extend from an inlet of the housing to the turbine. The turbocharger also has a valve mechanism disposed within the inlet of the housing. The valve mechanism has a valve element pivotally attached to an outer portion of the housing. The valve element is movable between a first position at which exhaust flow through the first annular passageway is blocked and a second position at which exhaust flows through both of the first and second annular passageways.

### TECHNICAL FIELD

The present disclosure is directed to a divided housing turbocharger and, more particularly, to a divided housing turbocharger with a variable nozzle area.

### BACKGROUND

Internal combustion engines such as, for example, diesel engines, gasoline engines, or natural gas engines may be operated to generate a power output. In order to maximize the power generated by the internal combustion engine, the engine may be equipped with a turbocharged air induction system.

A turbocharged air induction system may include a turbocharger that compresses the air flowing into the engine to thereby force more air into a combustion chamber of the engine than possible with a naturally-aspirated engine. The turbocharger is typically matched to perform efficiently when the engine is operating within a particular performance range (i.e., rated load and speed). When the engine operates outside of the particular performance range, the efficiency of the turbocharger may drop and the turbocharger could possibly malfunction. For example, when operating at low load and speed, the turbocharger may provide insufficient air for optimal combustion. Conversely, when the engine is operating at high load and speed, the turbocharger may tend to exceed a maximum allowable rotational speed.

One method of improving turbocharger efficiency and function throughout a range of engine operating conditions is to employ a variable nozzle area device. One such device is described in U.S. Pat. No. 3,557,549 issued to Webster et al. on Jan. 26, 1971. The '549 patent to Webster et al. describes a turbine having separate compartments and a flapper valve pivotally mounted to an inlet of the turbine. The flapper valve remains at a neutral position during periods of high engine speed and load and moves to a closed position at which it blocks exhaust flow into one of the separated compartments to divert all of the engine exhaust flow into the other of the separated compartments. By diverting all of the exhaust flow to only one of the separated compartments the velocity of the exhaust flow through that compartment increases, thereby resulting in increased turbine rotational speed. The higher turbine rotational speeds force more air into the engine, thereby improving combustion at low engine loads and speeds. The flapper valve of the '549 patent allows the turbocharger to be matched for efficient operation at high load and speed by opening both of the separated compartments, yet still provides sufficient air at low load and speed by selectively closing one of the separated compartments.

Although the flapper valve of the '549 patent may improve turbine efficiency and provide adequate air, it may not seal sufficiently. In particular, because the flapper valve of the '549 patent does not close against a valve seat, exhaust may leak past the flapper valve and reduce its effectiveness. Further, the shape of the flapper valve may restrict exhaust flow through the one of the separated compartments that is selectively blocked, while the opening swing direction of the flapper valve may make it difficult to unseat the flapper valve. In addition, the flapper valve of the '549 patent may deteriorate prematurely. In particular, the flapper valve of the '549 patent is always fully exposed to the degrading effects of the exhaust flow, regardless of the position of the flapper valve.

The turbocharger of the present disclosure solves one or more of the problems set forth above.

### SUMMARY OF THE INVENTION

A first aspect of the present disclosure is directed to a turbocharger. The turbocharger includes a turbine and a housing enclosing the turbine. The housing has a first annular passageway and a second annular passageway. Both of the first and second annular passageways extend from an inlet of the housing to the turbine. The turbocharger also includes a valve mechanism disposed within the inlet of the housing. The valve mechanism has a valve element pivotally attached to an outer portion of the housing. The valve element is movable between a first position at which exhaust flow through the first annular passageway is blocked and a second position at which exhaust flows through both of the first and second annular passageways.

A second aspect of the present disclosure is directed to a method of operating a turbocharger. The method includes directing an exhaust flow through a first annular passageway and a second annular passageway in a housing, from an inlet to a turbine. The method also includes selectively moving a valve element that is pivotally attached to an outer portion of the housing between a first position at which exhaust flow through the first annular passageway is blocked, and a second position at which exhaust flows through both of the first and second annular passageways.

### BRIEF DESCRIPTION OF THE DRAWINGS

FIG. 1 is a diagrammatic illustration of an exemplary disclosed power system;

FIG. 2; is a cross-sectional view illustration of an exemplary disclosed turbocharger for the power source of FIG. 1; and

FIG. 3 is an exploded view illustration of the turbocharger of FIG. 2.

### DETAILED DESCRIPTION

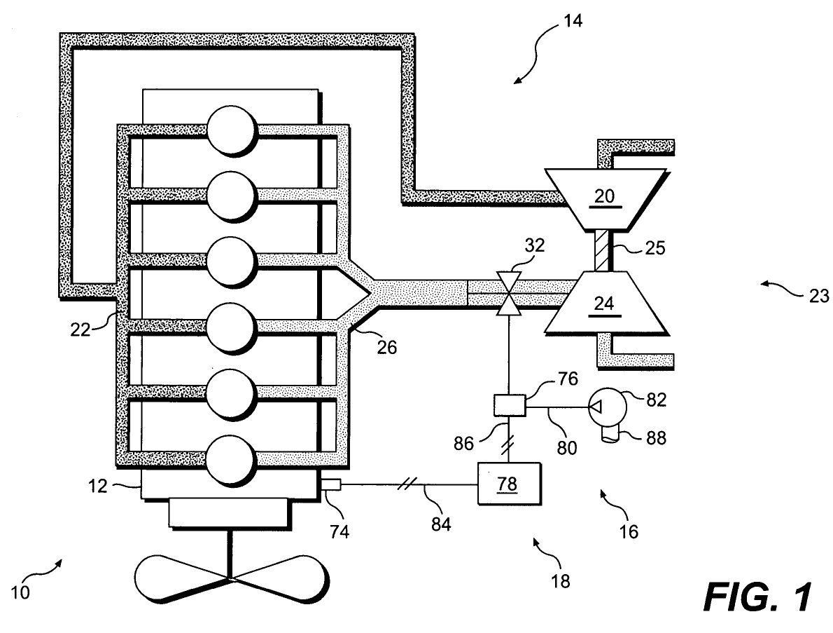

FIG. 1 illustrates an exemplary power system 10, which may include a power source 12. Power source 12 may embody an engine such as, for example, a diesel engine, a gasoline engine, a natural gas engine, or any other engine apparent to one skilled in the art. Power source 12 may receive intake air from an air induction system 14 and expel combustion byproducts to an exhaust system 16. Power system 10 may also include a control system 18 in communication with power source 12 and exhaust system 16.

Air induction system 14 may include a compressor 20 fluidly connected to an intake manifold 22 to direct compressed air into the combustion chambers of power source 12. Compressor 20 may include a fixed geometry type compressor, a variable geometry type compressor, or any other type of compressor known in the art. It is contemplated that more than one compressor 20 may be included and disposed in parallel or in series relationship. It is contemplated that additional components may be included within air induction system 14 such as, for example, air coolers, throttle valves, air cleaners, and other components known in the art.

Exhaust system 16 may include a turbocharger 23 having a turbine 24 fixedly connected to compressor 20 by way of a shaft 25. Hot exhaust gases may be directed away from the combustion chambers of power source 12 via an exhaust manifold 26 that is fluidly connected to turbine 24. The hot exhaust gases from power source 12 may expand against the blades (not shown) of turbine 24 and drive the rotation of the turbine 24 resulting in a corresponding rotation of compressor 20. It is contemplated that more than one turbine 24 may be included within exhaust system 16 and disposed in parallel or in series relationship. It is also contemplated that exhaust system 16 may include additional components such as, for example, exhaust filtering devices, exhaust treatment devices, exhaust gas recirculation components, and other components known in the art.

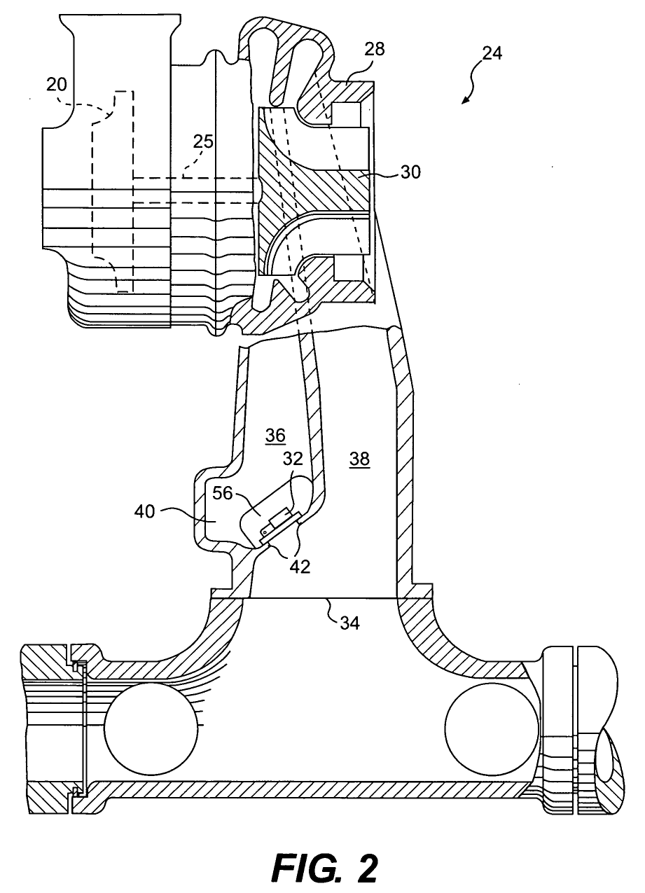

As illustrated in FIG. 2, turbocharger 23 may include a divided turbine housing 28 and a valve assembly 32. Divided turbine housing 28 may have an inlet 34, two annular passageways 36 and 38 that extend from inlet 34 to turbine 24, a recess 40 disposed within an outer wall of divided turbine housing 28, and a valve seat 42 configured to receive valve assembly 32. Exhaust gases from the combustion chambers of power source 12 may be directed from exhaust manifold 26 to turbine 24 by way of annular passageways 36 and 38. Annular passageway 36 may be selectively blocked by valve assembly 32, thereby directing all of the exhaust flow through annular passageway 38. Valve assembly 32 may be shielded from the exhaust gases when moved to the flow passing position within recess 40.

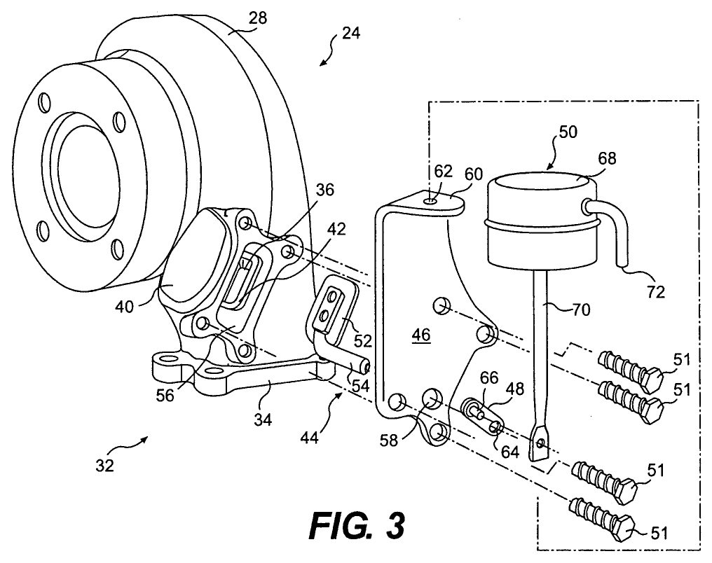

As illustrated in FIG. 3, valve assembly 32 may include numerous components that function together to selectively block annular passageway 36. In particular, valve assembly 32 may include a valve element 44, a cover plate 46, a connecting member 48, and an actuator 50. One or more fasteners 51 may be implemented to retain the components of valve assembly 32.

Valve element 44 may include a generally planar member 52 having a substantially square shape and being fixedly connected to a pivot shaft 54 that is distally located from a central portion of planar member 52. It is contemplated that valve element 44 may, alternatively, have a shape other than square such as rectangular, square, or any other appropriate shape. Planar member 52 may be pivoted via pivot shaft 54 between a flow passing position where planar member 52 is received within recess 40 and shielded from exhaust flow, and against a flow of exhaust toward a flow blocking position where planar member 52 mates against valve seat 42. The term blocked, for the purposes of this disclosure, is to be interpreted as at least partially restricted from air flow. It is contemplated that valve element 44, when in the flow blocking position, may fully restricted air flow through annular passageway 36.

Cover plate 46 may provide external access to valve element 44 while turbocharger 23 is assembled to power source 12. In particular, divided turbine housing 28 may include an opening 56 providing the access to valve element 44. Cover plate 46 may be removably attachable to divided turbine housing 28 to close off opening 56 during operation of turbocharger 23. It is contemplated that a seal such as, for example, a gasket (not shown) may be disposed between cover plate 46 and divided turbine housing 28 to minimize leakage from opening 56. Cover plate 46 may include a bore 58 through which pivot shaft 54 extends, and a support shelf 60 having a bore 62 for mounting actuator 50.

Connecting member 48 may include a bore 64 attachable to pivot shaft 54 and a pin 66 attachable to actuator 50. Because the axis of bore 64 and pin 66 are radially offset from each other, a linear motion of actuator 50 may be converted into a pivoting movement of valve element 44. Connecting member 48 may be assembled to pivot shaft 54 between cover plate 46 and actuator 50.

Actuator 50 may be pneumatically operated to initiate movement of valve element 44. Specifically, actuator 50 may include a spring-biased piston member (not shown) disposed within a pressure chamber 68 and fixedly connected to a piston rod 70. Pressurized air directed into pressure chamber 68 via an inlet 72 may urge the spring-biased piston member from a first position downward away from pressure chamber 68. Conversely, allowing the pressurized air to drain from pressure chamber 68 may allow the spring-biased piston member to return to the first position.

Control system 18 (referring to FIG. 1) may include components that function to regulate air flow to actuator 50 in response to one or more operational parameters of power source 12. In particular, control system 18 may include a sensor 74, a solenoid valve 76 disposed within an air passageway 80 between a source 82 of pressurized air and actuator 50 of valve assembly 32, and a controller 78. Controller 78 may be in communication with sensor 74 via a communication line 84 and with solenoid valve 76 via a communication line 86.

Sensor 74 may be associated with power source 12 to sense an operational parameter of power source 12 and to generate a signal indicative of the parameter. These operational parameters may include, for example, a load and/or a speed of power source 12. The load of power source 12 may be sensed by monitoring a fuel setting of power source 12, by sensing a torque and speed output of power source 12, by monitoring a timing of power source 12, by sensing a temperature of power source 12, or in any other manner known in the art. A speed of power source 12 may be sensed directly with a magnetic pick-up type sensor disposed on an output member of power source 12, or in any other suitable manner. It is contemplated that other operational parameters may alternatively or additionally be sensed by sensor 74 and communicated to controller 78 such as, for example, boost pressure, turbine speed, and other parameters known in the art.

Solenoid valve 76 may include a spring-biased valve element that is movable between a first position and a second position in response to an electronic signal from controller 78. When in the first position, pressurized air from source 82 may be communicated with pressure chamber 68 to cause piston rod 70 to extend relative to pressure chamber 68. When in the second position, the pressurized air from within pressure chamber 68 may be allowed to drain to the atmosphere, causing piston rod 70 to return to the retracted position relative to pressure chamber 68.

Controller 78 may be configured to receive the signal from sensor 74 and to selectively energize solenoid valve 76 in response to the signal. For example, the signal from sensor 74 may indicate that power source 12 is operating under low load and speed conditions where additional boost might be beneficial. In order to increase the boost provided to power source 12, controller 78 may cause solenoid valve 76 to move to the second position, thereby retracting piston rod 70 and causing valve element 44 to block annular passageway 36. Conversely, if the signal from sensor 74 indicates that power source 12 is operating under high load and speed conditions where excessive boost may cause the rotational speed of turbine 24 to exceed a maximum allowable speed, controller 78 may cause solenoid valve 76 to move to the first position, thereby extending piston rod 70 and causing valve element 44 to move to the flow passing position within recess 40.

Controller 78 may be embodied in a single microprocessor or multiple microprocessors that include a means for controlling an operation of turbocharger 23. Numerous commercially available microprocessors can be configured to perform the functions of controller 78. It should be appreciated that controller 78 could readily be embodied in a general power system microprocessor capable of controlling numerous power system functions. Controller 78 may include a memory, a secondary storage device, a processor, and any other components for running an application. Various other circuits may be associated with controller 78 such as power supply circuitry, signal conditioning circuitry, solenoid driver circuitry, and other types of circuitry.

Source 82 may be configured to produce a flow of pressurized air and may include a dedicated compressor such as, for example, a variable displacement compressor, a fixed displacement compressor, or any other source of pressurized air known in the art. Source 82 may be drivably connected to power source 12 by, for example, a countershaft 88, a belt (not shown), an electrical circuit (not shown), or in any other suitable manner. Alternatively, source 82 may be indirectly connected to power source 12 via a torque converter, a gear box, or in any other appropriate manner. It is contemplated that multiple sources of pressurized air may be interconnected to supply pressurized fluid to control system 18. It is also contemplated that a source 82 may be omitted, if desired, and the pressurized air directed from compressor 20 to actuator 50 via solenoid valve 76.

### INDUSTRIAL APPLICABILITY

The disclosed turbocharger may be applicable to any power system where turbocharger efficiency and function throughout a range operational conditions is desired. Turbocharger 23 may provide adequate boost at low power source load and speed conditions and may minimize the likelihood of turbocharger speeds exceeding a maximum allowable speed at high load and speed conditions by selectively directing all of the exhaust flow from power source 12 through only one or both of the two separated annular passageways 36 and 38.

In addition to providing adequate boost at low power source load and speed conditions and preventing turbine overspeed at high load and speed conditions, turbocharger 23 may provide additional advantages. In particular, because valve element 44 closes against valve seat 42, a greater amount of exhaust may be blocked from flowing through annular passageway 36 than if valve seat 42 were omitted. The increased amount of blockage may improve turbine efficiency and boost at low load and speed conditions. In addition, because valve element 44 has a square cross shape, the opening, which valve element 44 selectively closes off to block annular passageway 36, may also be square, providing increased flow area with minimal restriction, as compared to a valve element having a circular shape. Further, because valve element 44 is pivoted against a flow of exhaust when moving toward the flow blocking position and with the flow of exhaust when moving toward the flow passing position, it may be relatively easy to unseat valve element 44. In addition, because valve element 44 is shielded from exhaust flow within recess 40 when moved toward the flow passing position, valve element 44 may have increased component life and further reduce restriction within turbocharger 23, as compared to a valve element that always remains within the flow of exhaust.

It will be apparent to those skilled in the art that various modifications and variations can be made in the turbocharger of the present disclosure without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A turbocharger, comprising:
a turbine;
a housing enclosing the turbine and having a first annular passageway and a second annular passageway, both of the first and second annular passageways extending from an inlet of the housing to the turbine; and
a valve mechanism disposed within the inlet of the housing and having a valve element pivotally attached to an outer portion of the housing, the valve element movable between a first position at which exhaust flow through the first annular passageway is blocked and a second position at which exhaust flows through both of the first and second annular passageways.

2. The turbocharger of claim 1, wherein the housing further includes a recess configured to receive the valve element when the valve element is in the second position.

3. The turbocharger of claim 1, wherein the recess shields the valve element from at least a portion of the exhaust flow when the valve element is in the second position.

4. The turbocharger of claim 1, wherein the turbocharger is associated with a power source and the valve mechanism is externally accessible when the turbocharger is assembled to the power source.

5. The turbocharger of claim 4, further including:
a cover plate removably attachable to the turbine housing, the cover plate providing the external access to the valve element; and
an arm extending radially from the valve element and protruding through the cover plate.

6. The turbocharger of claim 5, further including an actuator mounted to the cover plate, operatively connected to the arm, and configured to move the valve element between the first and second positions.

7. The turbocharger of claim 6, wherein the actuator is pneumatically operated.

8. The turbocharger of claim 7, wherein the turbocharger is associated with a power source and the turbocharger further includes:
a solenoid configured to selectively direct pressurized air to the pneumatically operated actuator;
at least one sensor configured to generate a signal indicative of at least one parameter of the power source; and
a controller in communication with the sensor and the solenoid, the controller configured to selectively energize the solenoid in response to the signal.

9. The turbocharger of claim 8, wherein the at least one parameter is at least one of a speed and a load of the power source.

10. The turbocharger of claim 1, wherein the shape of the valve element is substantially square.

11. The turbocharger of claim 1, further including a valve seat disposed in the housing, the valve seat configured to receive the valve element when the valve element is in the first position.

12. The turbocharger of claim 1, wherein movement of the valve element toward the first position is against the flow of exhaust through the first annular passageway.

13. The turbocharger of claim 1, wherein the valve mechanism includes a pivot shaft distal from a central portion of the valve element.

14. A method of operating a turbocharger associated with a power source, comprising:
directing an exhaust flow through a first annular passageway and a second annular passageway in a housing from an inlet to a turbine;
selectively moving a valve element that is pivotally attached to an outer portion of the housing between a first position at which exhaust flow through the first annular passageway is blocked, and a second position at which exhaust flows through both of the first and second annular passageways.

15. The method of claim 14, further including shielding the valve element from at least a portion of the exhaust flow when the valve element is in the second position.

16. The method of claim 14, wherein shielding is achieved by the valve element being inside a recess formed within the housing.

17. The method of claim 14, wherein selectively moving the valve element includes operating an actuator pivotally connected to the valve element.

18. The method of claim 14, further including sensing at least one parameter of the power source and operating the actuator in response to the at least one parameter.

19. The method of claim 14, wherein moving the valve element to the first position includes engaging the valve element with a valve seat.

20. The method of claim 14, wherein moving the valve element to the first position includes pivoting the valve element against a flow exhaust.

21. A power system, comprising:
a power source;
an air induction system;
an exhaust system; and
a turbocharger in fluid communication with the air induction and exhaust systems, the turbocharger including:
a turbine;
a housing enclosing the turbine and having:
a first annular passageway and a second annular passageway, the first and second annular passageways extending from an inlet of the housing to the turbine;
a recess; and
a valve seat;
a valve mechanism disposed within the inlet of the housing and having a valve element pivotally attached to an outer portion of the housing, the valve element movable between a first position where the valve element engages the valve seat to block exhaust flow through the first annular passageway, and a second position at which exhaust flows through both of the first and second annular passageways, the valve element being received within and shielded from exhaust flow by the recess of the housing when the valve element is in the second position.

22. The power system of claim 20, further including a cover plate removably attachable to the turbine housing to provide external access to the valve element;
an arm extending radially from the valve element and protruding through the cover plate; and
an actuator mounted to the cover plate, operatively connected to the arm, and configured to move the valve element between the first and second positions.

23. The power system of claim 21, wherein the actuator is pneumatically operated.

24. The power system of claim 24, further including:
a solenoid configured to selectively direct pressurized air to the pneumatically operated actuator;
at least one sensor configured to generate a signal indicative of at least one parameter of the power source; and
a controller in communication with the sensor and the solenoid, the controller configured to selectively energize the solenoid in response to the signal.

25. The power system of claim 24, wherein the at least one parameter is at least one of a speed and a load of the power source.

26. The power system of claim 21, wherein the shape of the valve element is substantially square.

27. The power system of claim 21, wherein movement of the valve element toward the first position is against the flow of exhaust through the first annular passageway.

28. The power system of claim 21, wherein the valve mechanism includes a pivot shaft distal from a central portion of the valve element.
